(19) United States
(12) Patent Application Publication
(10) Pub. No.: US 2022/0289470 A1
(43) Pub. Date: Sep. 15, 2022

(54) BEVERAGE INGREDIENT CONTAINERS, METHODS OF MAKING AND METHODS OF USING THE SAME

(71) Applicant: Koninklijke Douwe Egberts B.V., Utrecht (NL)

(72) Inventors: James Close, Banbury (GB); Sian Henson, Banbury (GB); Ayse Tulay Massey, Banbury (GB); Luanga Nchari, Banbury (GB)

(21) Appl. No.: 17/635,302

(22) PCT Filed: Aug. 7, 2020
(86) PCT No.: PCT/EP2020/072289

§ 371 Date: Feb. 14, 2022

(30) Foreign Application Priority Data
Aug. 15, 2019 (GB) 1911711.8

(51) Int. Cl. B65D 85/804; A23G 1/56; A23C 9/15; A23L 2/395; A47J 31/40; B65B 29/02

(52) U.S. Cl. CPC B65D 85/8043; A23G 1/56; A23C 9/1508; A23L 2/395; A47J 31/407; B65B 29/022; A23V 2002/00

(57) ABSTRACT

The invention provides a beverage machine insertable container comprising pieces of compacted beverage ingredient powder or granules.

### TECHNICAL FIELD OF THE INVENTION

The present invention relates to beverage machine-insertable containers comprising pieces of a compacted beverage ingredient, methods of making the same and methods of using the same for the preparation of beverages.

### BACKGROUND TO THE INVENTION

When preparing a beverage from a powdered ingredient, it is known in the art, that powder solubility can be a problem, resulting in a drink with grainy texture or weak concentration and an undesirable leftover residue of wetted powder. Many options exist to the skilled person when faced with a problem of powder solubility, including, varying the type or blend of solvent, increasing the temperature or volume of the solvent, the introduction of shear or increasing powder-solvent contact time for example. Some of these options are of limited use in certain circumstances; for example, in applications that comprise milk powder, the effect of increasing temperature can reduce solubility. It is also known that the physical properties of the powder can have a dramatic effect on its solubility. Powders with the same chemical structure but different physical properties, such as density, particle size, particle size distribution or porosity, for example can have vastly different solubility. In some applications, such as containers for use in beverage preparation machines, it is known that various of these levers for adjusting solubility are restricted/limited or unavailable.

Many beverage preparation systems are known in the art. These systems usually comprise a beverage preparation machine and a beverage ingredient container, for use in conjunction with the beverage preparation machine. Beverage ingredient containers can be in the form of sachets, soft pads, semi-rigid pads, rigid pads, capsules, discs and pods of plastics or aluminium and can contain extractable and/or soluble beverage ingredients. Beverage preparation machines usually contain a water source, heat source and pump with which to deliver heated water through the beverage ingredient container and into a cup.

Typically, beverage ingredient containers are inserted into beverage preparation machines by a consumer when a beverage is made.

A typical beverage preparation machine is configured in use to deliver a predetermined volume and/or flow rate of water to the beverage ingredient container in order to dissolve, suspend and/or extract some or all of the beverage ingredient contained therein and then to dispense a beverage of a desirable volume and solids content. Typically, the amount of water delivered to the beverage ingredient container is determined by a timed activation of a water pump or by a set threshold on a flow meter, in either case the volume of water passed through the beverage ingredient container is limited.

In known systems, in the case where a beverage ingredient contained within the beverage ingredient container is soluble, there is often a residual amount of beverage ingredient left within the beverage ingredient container once the desired volume of water has been dispensed by the beverage preparation machine. This often results in a beverage with less than the desired amount of dissolved beverage ingredient and/or wasted beverage ingredient left within the beverage ingredient container once a beverage has been prepared. A known method of overcoming this problem is to add an excess of beverage ingredient to the beverage ingredient container to ensure that, even with a residue, sufficient beverage ingredient is dissolved by the desired volume of water and sufficient beverage ingredient is present in the prepared beverage. This improves the solids content of the beverage but increases the amount of wasted beverage ingredient left within the beverage ingredient container and causes significant difficulties in fitting the excess beverage ingredient into containers of the defined size used for each system. Furthermore, this effect has an upper practical limit. Above a threshold, the addition of more beverage ingredient powder has no effect on the solids content of the beverage that is produced or even can reduce the solubility of the bulk ingredient by limiting the headspace available within the container for mixing.

Further, it is known that, if beverage ingredient containers are stored incorrectly or for many months before use, the amount of residue can increase for a given beverage ingredient container, after the beverage ingredient has been extracted, dissolved or suspended.

It would be advantageous to provide formats of beverage ingredient that can withstand manufacturing processes required to fill beverage ingredient containers without significant breakage or disintegration into significant quantities of fine particles (“fines”).

It is also known in the art to manipulate the physical properties of beverage ingredients in order to affect their solubility, however, known solutions to improve solubility all have some other property that is detrimental to the desirable properties in a beverage preparation system. For example, known agglomeration techniques increase solubility of beverage powders and therefore may have an impact on reducing residues within beverage ingredient containers; however, the same known agglomerated beverage ingredient powders have reduced density and therefore sufficient mass of beverage ingredient cannot easily be added to the relatively small volume of a beverage ingredient container in order to create a beverage of desirable volume and solids content. Further, such known agglomerated powders, can also be incompatible with the processes involved in the manufacture of beverage ingredient containers such that their increased friability results in breakage of agglomerated powders during manufacture and handling; thereby increasing fine particles, and thus, reducing solubility; in turn creating more dust and hindering container sealing.

High levels of fines (>15%) and low porosity can also create significant dust in filling lines resulting in frequent cleaning of the lines reducing efficiency

Additionally, known beverage ingredient powders may lose solubility over the shelf life of a commercial product, and, thus, within reasonable storage times of months, residues may increase above acceptable levels.

It is known that such disadvantages are particularly associated with beverage ingredients that contain an amount of fat.

Known powders include those described in the following documents: WO2016/014503, WO2011/063322, WO2011/039027, WO2009/103592, WO2004/064585. Each one of these documents suffers from one or more of the disadvantages described above, such as, low porosity, high percentage fines, sub-optimal particle size, etc. Further, it is known that the properties of a fluid used to dissolve or otherwise transport beverage ingredients into a prepared beverage can impact the amount of beverage ingredient in the prepared beverage. Parameters of the fluid, such as, but not limited to, temperature, pressure, flow rate and/or aeration may be adjusted by adjusting settings and/or components in a beverage preparation machine. In particular, beverage preparation machines that operate at relatively low fluid pressures (i.e those below about 5-10 bar) suffer from poor solubility of beverage powders than those that operate at higher pressures (i.e. those above about 10 bar)

It is an aim of embodiments of the invention to create the optimum combination of beverage ingredient properties paired with optimum fluid properties provided by a beverage preparation machine in order to maximise the amount of beverage ingredient transported by the fluid to a prepared beverage. It is a further aim of embodiments of the invention to achieve this result in beverage preparation machines that provide a range of alternative beverages with a range of beverage ingredients and/or beverage ingredient containers.

It would be advantageous to provide a beverage ingredient container containing a soluble beverage ingredient that yields less residue after use in a beverage preparation machine.

It is an aim of embodiments of the invention to increase the solubility of beverage ingredients within the confined of beverage ingredient containers. Further, it is an aim of embodiments of the invention to increase the amount of beverage ingredient powder that can be added to a given volume of beverage ingredient container and/or reduce the volume or one or more dimensions of the beverage ingredient container whilst maintaining the same amount of beverage ingredient container it contains.

In would also be advantageous to provide a fat-containing beverage ingredient for use in beverage containers of the type described herein, which has reduced problems relating to storage, shelf-life, residue production and insufficient solubility.

It is therefore an aim of embodiments of the invention to mitigate or reduce a disadvantage presented by the prior art.

### SUMMARY OF THE INVENTION

According to a first aspect of the invention there is provided a beverage machine insertable container comprising pieces of compacted beverage ingredient powder or granules.

By “compacted” we mean that the granules or powder particles are pressed together to form larger pieces.

In some embodiments, each piece of beverage ingredient has a largest dimension of at least 1.5 mm, 2 mm, 3 mm, 4 mm or 5 mm. In some embodiments, each piece of beverage ingredient has a largest dimension of no more than 20 mm, 19 mm, 18 mm, 17 mm, 16 mm or 15 mm. In some embodiments, each piece of beverage ingredient has a largest dimension of between 1.5 mm-20 mm, 2 mm-20 mm, 2 mm-18 mm or 2 mm-15 mm.

Such large piece sizes provide for an enlarged space within the container for fluid flow and turbulence generation to aid in dissolution/suspension of the beverage ingredient. Further, embodiments with such piece sizes help to spread the wetting front of the beverage ingredient and prevent the formation of a single compacted layer of beverage ingredient to can be difficult to dissolve, especially when the powder comprises fat.

In some embodiments, at least two of the pieces of beverage ingredient are substantially uniform in size and/or shape. In some preferred embodiments, the variation in the largest dimension between each of the pieces of beverage ingredient within the container is less than 1%, 2%, 3%, 4%, 5% or 9% of the biggest piece. In some preferred embodiments, the variation in the largest dimension between each of the pieces of beverage ingredient within the container is no more than 20%, 18%, 16%, 15% or 10% of the biggest piece. In some preferred embodiments, the variation in the largest dimension between each of the pieces of beverage ingredient within the container is between 1%-20%, 1%-15%, 1%-10% or 2%-10% of the biggest piece. It will be appreciated that the pieces of beverage ingredient are likely to comprise a small number of pieces broken in packing or transport and accompanying dust that are excluded from the selection of maximum and minimum dimensions the purpose of this measurement. In further embodiments, each piece is substantially the same size and/or shape. Uniformity of shape amongst the pieces has the additional advantage of consistent dissolution/suspension and larger spaces between ingredient pieces for solvent to infiltrate.

In some embodiments, there are between 10-1000, 10-500 or 10-300 pieces of beverage ingredient within the beverage ingredient container.

Such piece count provides the additional advantage of packing efficiency, adequate prepared beverage concentration and container fill weight.

In some embodiments, at least one of, or preferably, each of the pieces of beverage ingredient have a density of at least 0.5 g/cm³, 0.6 g/cm³, 0.7 g/cm³, or 0.8 g/cm³. In some embodiments, at least one of, or preferably, each of the pieces of beverage ingredient have a density of no more than 2 g/cm³, 1.5 g/cm³, 1.4 g/cm³, 1.3 g/cm³, or 1.2 g/cm³. In some embodiments, at least one of, or preferably, each of the pieces of beverage ingredient have a density of between 0.5 g/cm³ and 2 g/cm³, 0.5 g/cm³ and 1.5 g/cm³, 0.6 g/cm³ and 1.4 g/cm³, or 0.7 g/cm³ and 1.3 g/cm³. In preferred embodiments, all of the pieces have substantially the same density.

Densities within these limits provide the additional advantages of optimised pack density within the confines of a machine insertable container, optimised headspace for fluid flow and solubility and reduced beverage ingredient residue. Uniformity of density amongst the pieces has the additional advantage of consistent dissolution/suspension.

In some embodiments, at least one of, or preferably, each of the pieces of beverage ingredient have a mass of at least 0.08 g, 0.1 g, 0.12 g or 0.15 g. In some embodiments, at least one of, or preferably, each of the pieces of beverage ingredient have a mass of no more than 0.55 g, 0.5 g or 0.45 g. In some embodiments, at least one of, or preferably, each of the pieces of beverage ingredient have a mass of between 0.08 g and 0.55 g, 0.1 g and 0.5 g, or 0.12 g and 0.45 g. In preferred embodiments, all of the pieces have substantially the same mass.

These mass ranges provide the additional advantage of optimum pack density within the confines of a beverage machine insertable container. Uniformity of mass amongst the pieces has the additional advantage of consistent dissolution/suspension.

In preferred embodiments, at least one of or, preferably, each of the pieces of beverage ingredient comprises a fat, sugar, a sweetener, milk powder, soluble coffee, dairy creamer, non-dairy creamer and/or chocolate powder. In some embodiments, at least one of or, preferably, each of, the pieces of beverage ingredient are a milk powder, dairy creamer, non-dairy creamer and/or chocolate powder. In some embodiments, at least one of or, preferably, each of the pieces of beverage ingredient comprises at least 5%, 6%, 7%, 8%, 9% or 10% wt fat. In some embodiments, at least one of or, preferably, each of the pieces of beverage ingredient comprises no more than 70%, 60%, 50%, 30%, or 20% wt fat. In some embodiments, at least one of or, preferably, each of the pieces of beverage ingredient comprises between 5% wt and 25% wt, 70% wt fat, preferably between 10%-25% wt; 5%-20% wt or 10%-20% wt fat by weight. In embodiments, where the at least one of or, preferably, each of the pieces of beverage ingredient pieces comprises chocolate powder; the powder comprises at least 4%, 4.5%, 5%, 5.5% or 6% wt fat and/or no more than 9%, 8.5%, 8%, 7.5% or 7% wt fat and/or between 4%-9% wt; 4%-8% wt; 4%-7% wt; 5%-9% wt; 5%-8% wt or 6%-8% wt fat. In further embodiments, where at least one of or, preferably, each of the pieces of beverage ingredient comprises a milk powder, the powder comprises at least 10%, 11% or 12% wt and/or no more than 30%, 25%, 22% or 20% wt fat and/or between 10%-25% wt, 10%-20% wt, 12%-25% wt or 12%-20% wt fat. In further embodiments, where at least one of, or preferably each of the pieces of beverage ingredient comprises a dairy creamer powder or a non-dairy creamer powder, the powder comprises at least 25% wt and/or no more than 70% wt fat and/or between 25%-70% wt fat.

Beverage powders that contain fat in such quantities as described here are known in the art to have lower solubility in water. Embodiments of the invention that have such fat content have the particular advantage of sufficient solubility to create a beverage with adequate solids content and low beverage ingredient residues.

In some embodiments, at least one of, or preferably, each of the pieces of beverage ingredient have a water activity of less than 0.45, 0.40, 0.39, 0.38 or less than 0.37, which may for example be measured by standard dew point measurement method on Aqua Lab 3 TE Series, and in preferred embodiments it is of less than 0.35 or less than 0.32, and most preferred between 0.20-0.30. Preferably, throughout storage the beverage ingredient maintains a water activity of less than 0.45. In other embodiments, each of the pieces has substantially the same water activity. Uniformity of water activity amongst the pieces have the additional advantages of consistent dissolution/suspension and consistent product shelf life.

Embodiments with low water activity have the additional advantage of excellent solubility after storage and consistent product performance over shelf-life.

In some embodiments, the beverage ingredient comprises an amount of dust making up less than 3 wt %, 2 wt %, 1 wt % or less than 0.5 wt % of the total amount of beverage ingredient in the container. Dust is defined as pieces of beverage ingredient that are significantly smaller than the pieces of beverage ingredient powder, such as less than 500 microns, 250 microns or 150 microns.

Embodiments with such levels of dust have the particular advantage of improved uniformity of solubility across the mass of beverage ingredient, in use.

In some embodiments, the beverage preparation machine insertable beverage ingredient container is selected from: a capsule, a disc, a pod, a pad, a semi-rigid pad, a filter bag, a pouch, a cartridge. In preferred embodiments, the beverage ingredient container has a volume of between 15 ml to 80 ml or 20 ml to 65 ml. In more preferred, embodiments, the beverage preparation machine insertable beverage ingredient container comprises a beverage preparation machine-readable portion.

Embodiments with such container volumes have the additional advantages of compatibility with beverage preparation machines and capacity for the capsule to communicate with the machine in order to optimise at least one parameter of the final beverage, for instance % beverage powder suspended/dissolved therein.

In some embodiments, the pieces of beverage ingredient powder or granules occupy at least 45%, 50%, 55%, 60%, 65%, 70%, 75% or 80% and/or no more than 95% or 90% of the total volume of the beverage ingredient container. In some preferred embodiments, the pieces of beverage ingredient powder or granules occupy between 45%-95%, or between 55%-95%, or between 65%-95%, or between 75%-95%, or between 45%-90%, or between 55%-90%, or between 65%-90% or between 75%-90% of the total volume of the beverage ingredient container.

In some embodiments, the particles of beverage ingredient powder or granules that make up the pieces of beverage ingredient have a median particle size, sometimes described as D50, of at least 200, 225, 250, 275 microns and/or no more than 900, 800, 700, 600, 550, 500 or 450 microns. In preferred embodiments, the median particle size is greater than 250 microns.

In some preferred embodiments, the particles of beverage ingredient powder or granules that make up the pieces of beverage ingredient have a median particle size of between 50 and 600, between 100 and 600 microns; between 100 and 400 microns; or especially, between 100 and 300 microns. Median particle size may be measured by laser diffraction method (e.g. Sympatec Helos equipment).

Beverage ingredient pieces comprising particles of these sizes create the optimal balance of powder or granule flowability in processing the pieces of compacted beverage ingredient, friability in packing and solubility in use.

In some embodiments, the beverage ingredient powder or granules comprises chocolate powder, in other embodiments, the beverage ingredient powder or granules comprises milk powder. In some embodiments, the pieces of beverage ingredient comprising chocolate powder or granules have a bulk density of at least 620 g/l; 640 g/l or 660 g/l. In some embodiments, the pieces of beverage ingredient comprising chocolate powder or granules have a bulk density of no more than 800 g/l, 750 g/l or 720 g/l. In some embodiments, the pieces of beverage ingredient comprising chocolate powder or granules have a bulk density of between 620 g/l to 800 g/l; 640 g/l to 750 g/l or between 660 g/l to 720 g/l.

In embodiments where the beverage ingredient powder or granules comprises milk powder, the bulk density of the pieces of beverage ingredient is at least 520 g/l; 540 g/l or 550 g/l. In some embodiments, the pieces of beverage ingredient comprising milk powder or granules have a bulk density of no more than 800 g/l, 750 g/l or 720 g/l. In some embodiments, the pieces of beverage ingredient comprising milk powder or granules have a bulk density of between 520 g/l to 800 g/l; 540 g/l to 750 g/l or between 550 g/l to 700 g/l.

Such densities provide the additional advantage of good balance between solubility and packing density within a machine insertable container.

According to a second aspect of the invention there is provided a method of preparing a beverage ingredient capsule of a first aspect of the invention comprising steps of:
a) providing a mass of a compacted beverage ingredient powder or granules;
b) breaking the mass of compacted beverage ingredient powder or granules into pieces of compacted powder or granules,
c) sieving the pieces formed in step b) and;
d) adding the beverage ingredient pieces of step b) to a beverage preparation machine insertable container.

In some embodiments, the container is subsequently sealed, preferably by heat sealing. A heat-sealed closure has the particular advantage of being readily pierced in order to extract the contents of the container in conjunction with a beverage preparation machine.

In some embodiments, the compacted mass of beverage ingredient powder or granules is produced by passing a beverage ingredient powder or granules between opposing rollers. In some embodiments, the force exerted between the opposing rollers is at least 0.5; 1 or 1.5 tons. In some embodiments, the force exerted between the opposing rollers is no more than 5.5 or 5 tons. In some embodiments, the force exerted between the opposing rollers is between 0.5 tons and 5 tons or between 1.5 tons and 5.5 tons.

Such compaction forces have the additional advantage of yielding a further optimised balance of solubility and packing density when loaded into the confines of a beverage machine insertable container.

According to a third aspect of the invention there is provided a method of preparing a beverage ingredient capsule of a first aspect of the invention comprising steps of:
a) providing a beverage ingredient powder or granules;
b) compacting the beverage ingredient powder or granules into individual pieces of compacted powder or granules, and;
c) adding the beverage ingredient pieces of step b) to a beverage preparation machine insertable container.

In some embodiments, the container is subsequently sealed, preferably by heat sealing. A heat-sealed closure has the particular advantage of being readily pierced in order to extract the contents of the container in conjunction with a beverage preparation machine.

In some embodiments, the force used to compact the beverage ingredient in step b) is at least 0.8 kN, 1 kN, or 1.2 kN. In some embodiments, the force used to compact the beverage ingredient in step b) is no more than 2.5 kN, 2.2 kN or 2 kN. In some embodiments, the force used to compact the beverage ingredient in step b) is between 0.8 kN and 2.5 kN or between 1 kN and 2.5 kN.

Such compaction forces have the additional advantage of yielding a further optimised balance of solubility and packing density when loaded into the confines of a beverage machine insertable container.

In some embodiments, the rate of compaction in step b) is at least 15 mm/min, 20 mm/min or 25 mm/min. In some embodiments, the rate of compaction in step b) is no more than 100 mm/min, 75 mm/min or 50 mm/min. In some embodiments, the rate of compaction in step b) is between 15 mm/min and 100 mm/min or between 15 mm/min and 50 mm/min.

According to a fourth aspect of the invention there is provided a method of preparing a beverage comprising steps of:
a) providing the beverage container of the first aspect of the invention;
b) transporting fluid through the container and dissolving and/or suspending at least a portion of at least some of the pieces in the fluid such that fluid exiting the container comprises at least a portion of the beverage ingredient dissolved and/or suspended therein, and;
c) collecting at least a portion of the solution or suspension of beverage ingredient in a second container.

In some embodiments, the amount of beverage ingredient dissolved and/or suspended in the fluid is greater than 75 wt %, 80 wt %, 85 wt % or 90 wt % of the beverage ingredient pieces present in the container prior to beverage preparation.

In some embodiments, there is a residue of beverage ingredient left in the container after beverage preparation of less than 25 wt %, 20 wt %, 15 wt %, or 10 wt % of the amount of beverage material in the container prior to beverage preparation.

In some embodiments, the volume of fluid transport in step b) is at least 10 ml, 25 ml or at least 50 ml. The volume of fluid transport in step b) may, for example be between 50 ml-300 ml.

In some embodiments, the fluid transported in step b) is transported under a pressure of less than 10 bar, 9 bar, 8 bar, 7 bar, 6 bar or, preferably, less than 5 bar.

### DETAILED DESCRIPTION OF THE INVENTION

In order that the invention may be more clearly understood embodiments thereof will now be described, by way of example only, with reference to the accompanying drawings, of which:

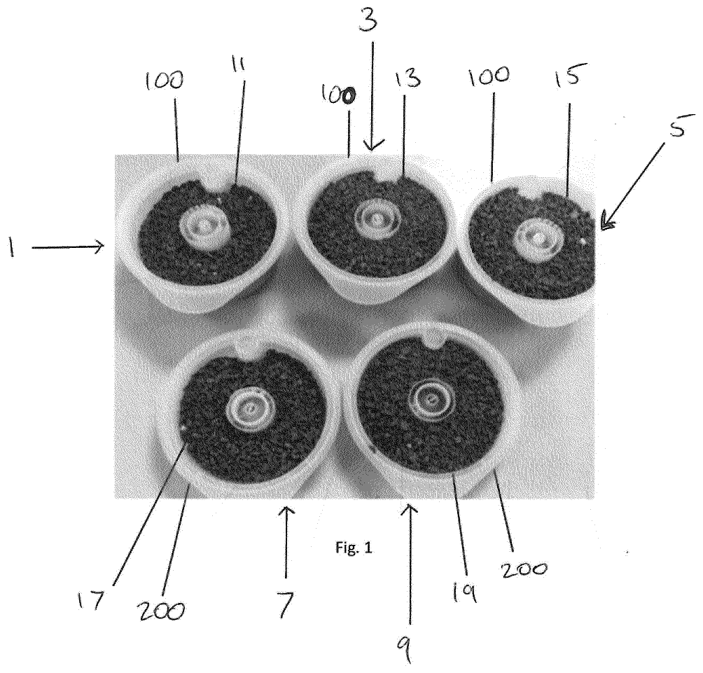

FIG. 1 shows images of containers of the invention in the form of t-discs, of Example 1, before the lid was applied and before brewing;

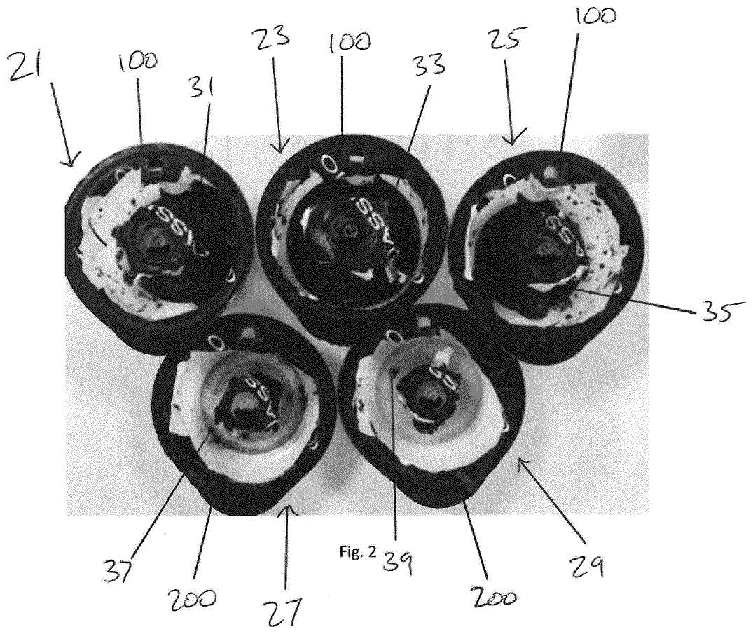

FIG. 2 shows images of residues in the t-disc of example 1 after brewing;

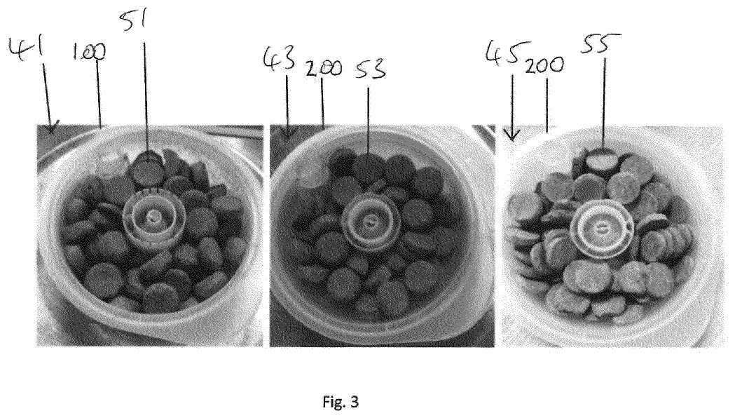

FIG. 3 shows images of containers of the invention in the form of t-discs, of example 3 before the lid was applied and before brewing; and

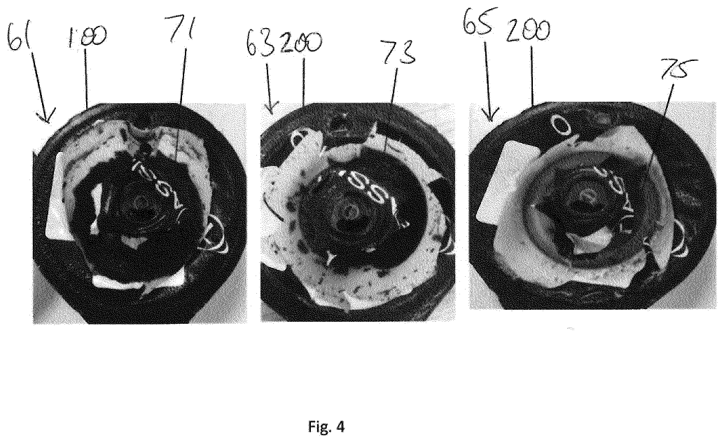

FIG. 4 shows images of residues in the t-discs of example 3 after brewing.

In the Figures, like numerals represent like or identical components.

With reference to FIG. 1, five beverage machine-insertable containers (1, 3, 5, 7, 9) (“t-discs”) filled with the pieces of compacted chocolate powder of the invention are shown Moving through the images clockwise from the top left: the first filled t-disc (1) comprises a big t-disc housing (100), and pieces of compacted powder (11); the second filled t-disc (3) comprises a big t-disc housing (100), and pieces of compacted powder (13); the third filled t-disc (5) comprises a big t-disc housing (100), and pieces of compacted powder (15); the fourth filled t-disc (7) comprises a small t-disc housing (200), and pieces of compacted powder (17); and the fifth filled t-disc (9) comprises a small t-disc housing (200), and pieces of compacted powder (19).

With reference to FIG. 2, the five beverage machine-insertable containers (21, 23, 25, 27, 29) of FIG. 1 are shown after use with the foil lid partially removed in order to see the relative amounts of residue left inside. Moving through the images clockwise from the top left: the first filled t-disc of FIG. 1, after use (21) comprises a big t-disc housing (100) and wet residue of compacted powder (31); the second filled t-disc of FIG. 1, after use (23) comprises a big t-disc housing (100) and wet residue of compacted powder (33); the third filled t-disc of FIG. 1, after use (25) comprises a big t-disc housing (100) and wet residue of compacted powder (35); the fourth filled t-disc of FIG. 1, after use (27) comprises a small t-disc housing (200) and wet residue of compacted powder (37); and the fifth filled t-disc of FIG. 1, after use (29) comprises a small t-disc housing (200) and wet residue of compacted powder (39).

With reference to FIG. 3, three beverage machine-insertable containers (41, 43, 45) filled with alternative pieces of compacted chocolate powder of the invention are shown. Moving through the images from left to right: the sixth filled t-disc (41) comprises a big t-disc housing (100) and alternative pieces of compacted powder (51); the seventh filled t-disc (43) comprises a small t-disc housing (200) and alternative pieces of compacted powder (53); and the eighth filled t-disc (45) comprises a small t-disc housing (200), and alternative pieces of compacted powder (55).

With reference to FIG. 4, the three beverage machine-insertable containers (41, 43, 45) filled with alternative pieces of compacted chocolate powder of FIG. 3 are shown after use with the foil lid partially removed in order to see the relative amounts of residue left inside. Moving through the images from left to right: the sixth filled t-disc of FIG. 3, after use (61) comprises a big t-disc housing (100) and wet residue of compacted powder (71); the seventh filled t-disc of FIG. 3, after use (63) comprises a small t-disc housing (200) and wet residue of compacted powder (53); and the eighth filled t-disc of FIG. 3, after use (65) comprises a small t-disc housing (200) and wet residue of compacted powder (75).

Big t-disc housings (100) for all Examples have an internal volume of about 56 ml and small t-disc housings (200) have an internal volume of about 25 ml.

### EXAMPLE 1

An embodiment of a beverage machine insertable container comprising pieces of a compacted chocolate powder of the first aspect of the invention produced by the method of the second aspect of the invention was produced and tested as set out below.

A control chocolate powder, comprising 42% sucrose, 22% skimmed milk powder, 10% whole milk powder, 9% cocoa powder, 3% coconut oil, 6% glucose syrup solids, 5% sweet whey powder and some additional minor ingredients such as flavourings was provided. The control chocolate powder had a median particle size of 180 microns and other physical properties as shown in Table 1.

TABLE 1
Chocolate powders

| | Bulk density | Bed | Water |
|---|---|---|---|
| Sample | (g/l) | porosity | activity |
| Control chocolate powder | 600 | 0.4 | 0.371 |
| Pieces of compacted chocolate | 690 | 0.525 | 0.352 |
| powder of the invention | | | |

A portion of the control chocolate powder was passed between two opposing rollers, each of 20 mm width and 200 mm diameter, in order to produce a sheet of compacted chocolate powder. The rollers were rotated at a rate of 10 rpm and had a force applied between them of around 1 ton. The sheet of compacted chocolate powder was then broken in a dry mixer and the product sieved through a 1.8 mm sieve. Product that passed through the sieve was rejected and reworked through the process. Pieces of compacted chocolate powder of the invention (11, 13, 15, 17, 19) remained on the sieve.

Portions of the pieces of compacted chocolate powder of the invention (11, 13, 15, 17, 19) and, separately, portions of the control chocolate powder were loaded into standard big and small Tassimo® t-discs (100, 200) and brewed using the respective big and small disc standard Milka® chocolate programmes on a Tassimo chassis 6 brewer and average residue remaining in the discs after 5 repetitions of each was measured, as shown in Table 2. The residues (31, 33, 35, 37, 39) were dried in a vacuum drier before measurements of the residue were taken.

The Tassimo® chassis 6 machine provides water heated to between 85 and 95° C. and target drink volume of 160 ml to 235 ml

TABLE 2
Brew performance control chocolate powder
vs compacted chocolate powder

| | | | | Average % |
|---|---|---|---|---|
| Test | | T - disc | Fill weight | dry residue |
| # | Sample | size | (g) | after brew |
| Control | Control chocolate powder | Big | 30 | 12 |
| Control | Control chocolate powder | Small | 11.5 | 6 |
| 1 | Pieces of compacted | Big | 30.25 | 8.10 |
| | chocolate powder of the | | | |
| | invention | | | |
| 2 | Pieces of compacted | Big | 38.15 | 10.62 |
| | chocolate powder of the | | | |
| | invention | | | |
| 3 | Pieces of compacted | Big | 35.41 | 4.91 |
| | chocolate powder of the | | | |
| | invention | | | |
| 4 | Pieces of compacted | Small | 11.63 | 2.41 |
| | chocolate powder of the | | | |
| | invention | | | |
| 5 | Pieces of compacted | Small | 17 | 1.94 |
| | chocolate powder of the | | | |
| | invention | | | |

Referring to FIG. 1, the first filled t-disc (1) was used in Test 1; the second filled t-disc (3) was used in Test 2; the third filled t-disc (5) was used in Test 3; the fourth filled t-disc (7) was used in Test 4; and the fifth filled t-disc (9) was used in Test 5. The t-discs shown (1, 3, 5, 7, 9) are shown filled to various fill weights of the compacted chocolate powder of the invention as set out in Table 2 prior to brewing.

Referring to FIG. 2, t-discs (21, 23, 25, 27, 29) are shown opened and after brewing to show the relative amount residues that remain in each disc and correspond to the t-discs of FIG. 1 (1, 3, 5, 7, 9, respectively). FIG. 2 shows the residue remaining in the disc of Test 1 (31), the residue remaining in the disc of Test 2 (33), the residue remaining in the disc of Test 3 (35), the residue remaining in the disc of Test 4 (37) and the residue remaining in the disc of Test 5 (39).

For the same fill weight, the pieces of compacted chocolate powder of the invention were shown to give less residue in the disc after brewing than the control product. Even at increased fill weights the compacted product of the invention gave lower residues showing the benefit of the invention over the control as a means of reducing the size of disc required for a given drink volume or increasing the maximum size of drink that can be prepared or increasing the concentration of a given drink.

### EXAMPLE 2

An embodiment of a beverage machine insertable container comprising pieces of a compacted milk powder of the first aspect of the invention produced by the method of the second aspect of the invention was produced and tested in the same way as the chocolate powder in Example 1.

The control milk powder contained 64% skimmed milk powder, 27.5% sugar and 8.25% Cream powder (total fat of 7.9%). The powder was processed in the same ways as the chocolate powder of Example 1 to yield pieces of compacted milk powder of the invention.

Portions of the pieces of compacted milk powder of the invention and, separately, portions of the control milk powder were loaded into standard big Tassimo® t-discs and brewed using the big disc standard milk programmes on a Tassimo® chassis 6 brewer and average residue remaining in the discs after 5 repetitions of each was measured, as shown in Table 3. The residue was dried in a vacuum drier before measurements were taken.

TABLE 3
Brew performance control milk powder vs compacted milk powder

| | | | | Average % |
|---|---|---|---|---|
| Test | | T - disc | Fill weight | dry residue |
| # | Sample | size | (g) | after brew |
| Control | Control milk powder | Big | 30 | 8 |
| 6 | Pieces of compacted milk | Big | 30.2 | 6.2 |
| | powder of the invention | | | |
| 7 | Pieces of compacted milk | Big | 38.15 | 7.6 |
| | powder of the invention | | | |

For the same fill weight, the pieces of compacted milk powder of the invention were shown to give less residue in the disc after brewing than the control product. Even at increased fill weights the compacted product of the invention gave lower residues showing the benefit of the invention over the control as a means of reducing the size of disc required for a given drink volume or increasing the maximum size of drink that can be prepared or increasing the concentration of a given drink.

### EXAMPLE 3

An embodiment of a beverage machine insertable container comprising pieces of a compacted chocolate powder of the first aspect of the invention produced by the method of the third aspect of the invention was produced and tested as set out below.

The control chocolate powder of Example 1, comprising 42% sucrose, 22% skimmed milk powder, 10% whole milk powder, 9% cocoa powder, 3% coconut oil, 6% glucose syrup solids, 5% sweet whey powder and some additional minor ingredients such as flavourings was provided. The control chocolate powder had a median particle size of 180 microns and other physical properties as shown in Table 1.

A portion of the control chocolate powder was passed between 2 opposing rollers comprising opposing cavities with which to form pieces of compacted powder. The cavities were broadly disc-shaped with a diameter of 10 mm and depth of 1.25 mm or 2.25 mm (to form corresponding pieces of 2.5 mm, or 4.5 mm thickness) in turn to form two batches of samples of alternative compacted pieces of chocolate powder of the invention with different dimensions. The rollers were rotated at a rate of 30 mm/min and had a force applied between them of around 1.5 kN. The resultant alternative compacted pieces of chocolate powder of the invention had physical properties as show in Table 4.

TABLE 4
Physical properties of the batches of the alternative
pieces of compacted chocolate powder of the invention.

| | Diameter | Height | Piece weight |
|---|---|---|---|
| Sample | (mm) | (mm) | (g) |
| Alternative pieces of | 10 | 4.5 | 0.35 |
| compacted chocolate powder of | | | |
| the invention - Batch 1 | | | |
| Alternative pieces of | 10 | 2.5 | 0.2 |
| compacted chocolate powder of | | | |
| the invention - Batch 2 | | | |

Each of the two batches of the pieces of compacted chocolate powder of the invention and, separately, portions of the control free-flowing chocolate powder were loaded into standard big and small Tassimo® t-discs (100, 200, respectively) and brewed using the respective big and small disc standard Milka® chocolate programmes on a Tassimo® chassis 6 brewer and average residue remaining in the discs after five repetitions of each was measured, as shown in Table 5. The residues (71, 73, 75) were dried in a vacuum drier before measurement of each residue was taken.

The Tassimo® chassis 6 machine provides water heated to between 85 and 95° C. and target drink volume of 160 ml to 235 ml

TABLE 5
Brew performance control chocolate powder
vs alternative compacted chocolate powder

| | | | | Average % |
|---|---|---|---|---|
| Test | | T - disc | Fill weight | dry residue |
| # | Sample | size | (g) | after brew |
| Control | Control chocolate powder | Big | 30 | 12 |
| Control | Control chocolate powder | Small | 11.5 | 6 |
| 8 | Alternative pieces of | Big | 30.1 | 10.5 |
| | compacted chocolate | | | |
| | powder of the invention - | | | |
| | Batch 1 | | | |
| 9 | Alternative pieces of | Small | 11.68 | 5.2 |
| | compacted chocolate | | | |
| | powder of the invention - | | | |
| | Batch 1 | | | |
| 10 | Alternative pieces of | Big | 30.1 | 1.85 |
| | compacted chocolate | | | |
| | powder of the invention - | | | |
| | Batch 2 | | | |
| 11 | Alternative pieces of | Small | 13 | 2.46 |
| | compacted chocolate | | | |
| | powder of the invention - | | | |
| | Batch 2 | | | |

Referring to FIG. 3, the sixth filled t-disc (41) was used in Test 8; the seventh filled t-disc (43) was used in Test 9 and the eighth filled t-disc (45) was used in Test 11. The t-discs shown (41, 43, 45) are shown filled to various fill weights as set out in Table 5 prior to brewing with either Batch 1 or Batch 2 of the alternative pieces of compacted chocolate powder of the invention of Table 4 prior to brewing.

Referring to FIG. 4, the t-discs (61, 63, 65) are shown opened and after brewing to show the relative amount residues that remain in each disc and correspond to the t-discs of FIG. 3 (41, 43, 45, respectively). FIG. 4 shows the residue remaining in the disc of Test 8 (61), the residue remaining in the disc of Test 9 (63), the residue remaining in the disc of Test 11 (65).

The pieces of the alternative compacted chocolate powder of the invention from Batch 1 with individual piece weight of 0.35 g were shown to give less residue in the disc after brewing than the control product.

The pieces of the alternative compacted chocolate powder of the invention from Batch 2 with individual piece weight of 0.2 g were shown to give very significantly less residue in the disc after brewing than the control product and less residue than the example of batch 1 using pieces of 0.35 g. This is believed to be because of the improved surface area to volume ratio of including more, smaller pieces of compacted powder.

The above embodiments are described by way of example only. Many variations are possible without departing from the scope of the invention as defined in the appended claims.

1. A beverage machine insertable container comprising pieces of compacted beverage ingredient powder or granules.

2. The beverage machine insertable container of claim 1 wherein at least one piece of beverage ingredient has a largest dimension of at least 1.5 mm.

3. The beverage machine insertable container of claim 1 wherein the variation in the largest dimension between each of the pieces of beverage ingredient within the container is less than 10% of the biggest piece.

4. The beverage machine insertable container of claim 1 wherein at least one of the pieces of beverage ingredient has a density of between 0.5 g/cm³ and 2 g/cm³.

5. The beverage machine insertable container of claim 1 wherein at least one of the pieces of beverage ingredient has a mass of at least 0.08 g.

6. The beverage machine insertable container of claim 1 wherein at least two of the pieces of beverage ingredient are substantially uniform in at least one of size, shape, density or mass.

7. The beverage machine insertable container of claim 6 wherein all of the pieces of beverage ingredient are substantially uniform in at least one of size, shape, density or mass.

8. The beverage machine insertable container of claim 1 wherein the particles of beverage ingredient powder or granules that make up the pieces of beverage ingredient have a median particle size of between 50 μm and 600 μm.

9. The beverage machine insertable container of claim 1 wherein at least one of the pieces of beverage ingredient comprises at least one ingredient selected from the list of: a fat, sugar, a sweetener, milk powder, soluble coffee, dairy creamer, non-dairy creamer or chocolate powder.

10. The beverage machine insertable container of claim 1 wherein at least one of the pieces of beverage ingredient, and preferably a majority or all of the pieces, comprises at least 5 wt. % fat.

11. The beverage machine insertable container of claim 1 wherein the beverage ingredient comprises an amount of dust making up less than 3 wt. % of the total amount of beverage ingredient in the container.

12. The beverage machine insertable container of claim 1 wherein the beverage ingredient container has a volume of between 15 ml to 80 ml.

13. A method of preparing a beverage ingredient capsule of claim 1 comprising steps of:
a. providing a mass of a compacted beverage ingredient powder or granules;
b. breaking the mass of compacted beverage ingredient powder or granules into pieces,
c. sieving the pieces formed in step b) and;
d. adding the beverage ingredient pieces of step b) to a beverage preparation machine insertable container.

14. The method of claim 13 wherein the compacted mass of beverage ingredient powder or granules of step a) is produced by passing a beverage ingredient powder or granules between opposing rollers.

15. A method of preparing a beverage ingredient capsule of claim 1 comprising steps of:
a. providing a beverage ingredient powder or granules;
b. compacting the beverage ingredient powder or granules into individual pieces, and;
c. adding the beverage ingredient pieces of step b) to a beverage preparation machine insertable container.

16. The method of claim 15 wherein the force used to compact the beverage ingredient in step b) is between 0.8 kN and 2.5 kN.

17. A method of preparing a beverage comprising steps of:
a. providing the beverage container of claim 1;
b. transporting fluid through the container and dissolving and/or suspending at least a portion of at least some of the pieces in the fluid such that fluid exiting the container comprises at least a portion of the beverage ingredient dissolved and/or suspended therein, and;
c. collecting at least a portion of the solution or suspension of beverage ingredient in a second container.

18. The method of claim 17 wherein there is a residue of beverage ingredient left in the container after beverage preparation of less than 25%. wt of the amount of beverage material in the container prior to beverage preparation.

19. The method of claim 17 wherein the fluid transported in step b) is transported under a pressure of less than 10 bar.
